(19) United States
(12) Patent Application Publication
(10) Pub. No.: US 2026/0278920 A1
(43) Pub. Date: Sep. 17, 2026

(54) SHADOW GENERATION

(71) Applicant: Tencent Technology (Shenzhen) Company Limited, Shenzhen (CN)

(72) Inventor: Dong XU, Shenzhen (CN)

(73) Assignee: Tencent Technology (Shenzhen) Company Limited, Shenzhen (CN)

(21) Appl. No.: 19/679,395

(22) Filed: May 15, 2026

Related U.S. Application Data
(63) Continuation of application No. PCT/CN2025/082844, filed on Mar. 17, 2025.

(30) Foreign Application Priority Data
Apr. 12, 2024 (CN) 202410444986.5

(51) Int. Cl. G06T 15/60; G06T 15/20; G06T 17/20

(52) U.S. Cl. CPC G06T 15/60; G06T 15/20; G06T 17/20

(57) ABSTRACT

Light source information of a virtual light source and one or more observation parameters of a virtual camera are obtained. Based on the light source information and the one or more observation parameters, a multi-angle contour map of the three-dimensional model is generated. The multi-angle contour map is a combination of a plurality of binary contour images of the three-dimensional model from different angles. Based on the light source information and the one or more observation parameters, the multi-angle contour map is projected onto a reference plane, to obtain a hard shadow image. A shadow feature of the three-dimensional model is obtained based on the light source information and a material attribute of the three-dimensional model. The hard shadow image and the shadow feature are input into a convolutional neural network-based shadow prediction model to generate a soft shadow image of the three-dimensional model.

### RELATED APPLICATIONS

The present application is a continuation of International Application No. PCT/CN2025/082844, filed on Mar. 17, 2025, which claims priority to Chinese Patent Application No. 202410444986.5, filed on Apr. 12, 2024. The entire disclosures of the prior applications are hereby incorporated by reference.

### FIELD OF THE TECHNOLOGY

This disclosure relates to the field of computer technologies, including a shadow generation method and apparatus for a three-dimensional model, a computer device, a storage medium, and a computer program product.

### BACKGROUND

Shadow effect adjustment is an important operation for enhancing sense of reality and a depth of a three-dimensional model. A proper shadow can make the three-dimensional model more stereoscopic, and can also improve a visual effect. Usually, a corresponding shadow effect may be added based on a light source in a virtual scene. In rendering of a virtual scene, many three-dimensional models perform shadow rendering on illumination. However, due to a model or a rendering sequence of the three-dimensional models, a rendering failure of a shadow effect occurs.

In some technologies, a geometric shadow map algorithm for triangle reconstruction based on computer graphics is usually used for shadow reconstruction of a three-dimensional model in a virtual scene. However, a large amount of calculation is needed in this manner. Consequently, shadow generation efficiency is low, and real-time shadow reconstruction in a virtual scene is hard to implement.

### SUMMARY

Some aspects of the disclosure provide a method of shadow generation. In some examples, light source information of a virtual light source and one or more observation parameters of a virtual camera are obtained. The light source information indicates an illumination effect of the virtual light source in a virtual scene, and the one or more observation parameters define a field-of-view range of the virtual camera in the virtual scene with a three-dimensional model. Based on the light source information and the one or more observation parameters, a multi-angle contour map of the three-dimensional model is generated. The multi-angle contour map is a combination of a plurality of binary contour images of the three-dimensional model from different angles. Based on the light source information and the one or more observation parameters, the multi-angle contour map is projected onto a reference plane, to obtain a hard shadow image of the three-dimensional model. A shadow feature of the three-dimensional model is obtained based on the light source information and a material attribute of the three-dimensional model. The hard shadow image and the shadow feature are input into a convolutional neural network-based shadow prediction model that has been trained to cause the convolutional neural network-based shadow prediction model to output a soft shadow image of the three-dimensional model.

Some aspects of the disclosure provide an apparatus that includes processing circuitry configured to perform any of the methods described herein.

Some aspects of the disclosure provide a non-transitory computer-readable storage medium storing instructions which when executed by at least one processor cause the at least one processor to perform any of the methods described herein.

Embodiments of this disclosure include a shadow generation method for a three-dimensional model. The method includes: obtaining light source information of a virtual light source and an observation parameter of a virtual camera, the light source information being configured for forming an illumination effect of the virtual light source in a virtual scene, and the observation parameter being configured for forming a field-of-view range of the virtual camera in the virtual scene for a three-dimensional model; generating, based on the light source information and the observation parameter, a multi-angle contour map corresponding to the three-dimensional model, the multi-angle contour map being configured for representing an initial shadow; projecting, based on the light source information and the observation parameter, the multi-angle contour map onto a reference plane, to obtain a hard shadow image corresponding to the three-dimensional model; obtaining a shadow feature of the three-dimensional model based on the light source information and a material attribute of the three-dimensional model; and inputting the hard shadow image and the shadow feature into a convolutional neural network-based trained shadow prediction model, and outputting, based on the hard shadow image and the shadow feature through the shadow prediction model, a soft shadow image corresponding to the three-dimensional model.

According to the embodiments of this disclosure, this disclosure further provides a shadow generation apparatus for a three-dimensional model. The apparatus includes: an obtaining module, configured to obtain light source information of a virtual light source and an observation parameter of a virtual camera, the light source information being configured for forming an illumination effect of the virtual light source in a virtual scene, and the observation parameter being configured for forming a field-of-view range of the virtual camera in the virtual scene for a three-dimensional model; a contour extraction module, configured to generate, based on the light source information and the observation parameter, a multi-angle contour map corresponding to the three-dimensional model, the multi-angle contour map being configured for representing an initial shadow; a hard shadow generation module, configured to project, based on the light source information and the observation parameter, the multi-angle contour map onto a reference plane, to obtain a hard shadow image corresponding to the three-dimensional model; a shadow feature extraction module, configured to obtain a shadow feature of the three-dimensional model based on the light source information and a material attribute of the three-dimensional model; and a prediction module, configured to input the hard shadow image and the shadow feature into a convolutional neural network-based trained shadow prediction model, and output, based on the hard shadow image and the shadow feature through the shadow prediction model, a soft shadow image corresponding to the three-dimensional model.

According to the embodiments of this disclosure, this disclosure further provides a computer device. The computer device includes a memory and a processor (an example of processing circuitry), the memory having computer-readable instructions stored therein, and the processor, when executing the computer-readable instructions, implementing operations of the shadow generation method for a three-dimensional model.

According to the embodiments of this disclosure, this disclosure further provides a computer-readable storage medium (e.g., non-transitory computer-readable storage medium). The computer-readable storage medium has computer-readable instructions stored therein, the computer-readable instructions, when executed by a processor, implementing operations of the shadow generation method for a three-dimensional model.

According to the embodiments of this disclosure, this disclosure further provides a computer program product. The computer program product includes computer-readable instructions, the computer-readable instructions, when executed by a processor, implementing operations of the shadow generation method for a three-dimensional model.

Details of one or more embodiments of this disclosure are provided in the following drawings and descriptions. Other features, objectives, and advantages of this disclosure become apparent in the specification, the accompanying drawings, and the claims.

### BRIEF DESCRIPTION OF THE DRAWINGS

FIG. 1 is a diagram of an application environment of a shadow generation method for a three-dimensional model according to some embodiments.

FIG. 2 is a schematic flowchart of a shadow generation method for a three-dimensional model according to some embodiments.

FIG. 3 is a schematic diagram of a hard shadow and a soft shadow according to some embodiments.

FIG. 4 is a schematic flowchart of generating, based on light source information and an observation parameter, a multi-angle contour map corresponding to a three-dimensional model according to some embodiments.

FIG. 5 is a schematic diagram of binary contour images corresponding to a three-dimensional model from different angles according to some embodiments.

FIG. 6 is a schematic diagram of a multi-angle contour map corresponding to a three-dimensional model according to some embodiments.

FIG. 7 is a schematic flowchart of extracting binary contour images from a plurality of angles according to some embodiments.

FIG. 8 is a schematic flowchart of projecting a multi-angle contour map onto a reference plane to obtain a hard shadow image according to some embodiments.

FIG. 9 is a schematic flowchart of obtaining a shadow feature map of a three-dimensional model based on light source information and a material attribute of the three-dimensional model.

FIG. 10 is a schematic diagram of a framework of a shadow generation method for a three-dimensional model according to some embodiments.

FIG. 11 is a block diagram of a structure of a shadow generation apparatus for a three-dimensional model according to some embodiments.

FIG. 12 is a diagram of an internal structure of a computer device according to some embodiments.

FIG. 13 is a diagram of an internal structure of a computer device according to some other embodiments.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

Solutions provided in the embodiments of this disclosure relate to technologies like a convolutional neural network of artificial intelligence, and are described by using the following embodiments as examples.

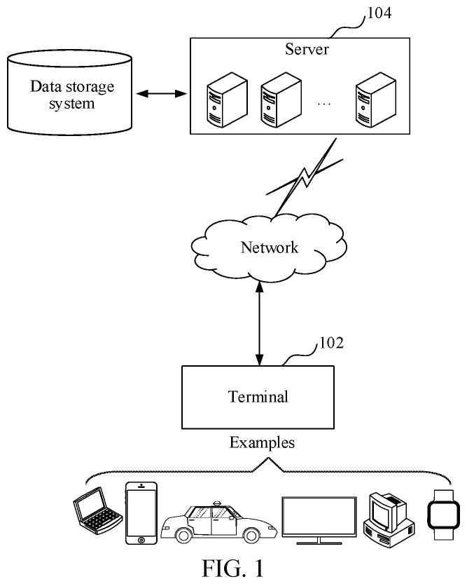

A shadow generation method for a three-dimensional model provided in an embodiment of this disclosure may be applied to an application environment shown in FIG. 1. A terminal 102 communicates with a server 104 via a network. A data storage system may store data to be processed by the server 104. The data storage system may be integrated on the server 104, or may alternatively be placed on a cloud or another server. The terminal 102 may obtain light source information of a virtual light source and an observation parameter of a virtual camera, the light source information being configured for representing an illumination effect of the virtual light source in a virtual scene, and the observation parameter being configured for representing a field-of-view range of the virtual camera in the virtual scene for a three-dimensional model; generate, based on the light source information and the observation parameter, a multi-angle contour map corresponding to the three-dimensional model, the multi-angle contour map being configured for representing an initial shadow; project, based on the light source information and the observation parameter, the multi-angle contour map onto a reference plane, to obtain a hard shadow image corresponding to the three-dimensional model; obtain a shadow feature of the three-dimensional model based on the light source information and a material attribute of the three-dimensional model; and input the hard shadow image and the shadow feature into a convolutional neural network-based trained shadow prediction model, and output, based on the hard shadow image and the shadow feature through the shadow prediction model, a soft shadow image corresponding to the three-dimensional model. In other words, a single multi-angle contour map generation process with low consumption is required, and then the hard shadow image of the three-dimensional model is generated based on the multi-angle contour map. Therefore, the soft shadow image of the three-dimensional model, that is, a shadow effect of the three-dimensional model, can be efficiently generated based on the hard shadow image and the shadow feature, so that a data processing volume during shadow generation is reduced, and shadow generation efficiency is improved.

The foregoing shadow generation method for a three-dimensional model may alternatively be performed by the server 104. The terminal 102 may obtain the generated soft shadow image from the server 104. In an embodiment, the terminal 102 may further render the shadow effect based on the soft shadow image, to make display of the three-dimensional model in the virtual scene more real and natural.

The terminal 102 may be, but is not limited to, a desktop computer, a notebook computer, a smartphone, a tablet computer, an Internet of things device, or a portable wearable device. The Internet of things device may be a smart speaker, a smart television, a smart air conditioner, a smart in-vehicle device, or the like. The portable wearable device may be a smartwatch, a smart bracelet, a head-mounted device, or the like. The server 104 may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and big data and an artificial intelligence platform.

In an embodiment, an application (or a client) supporting the virtual scene is installed and run on the terminal 102. The application may be a competition-type program or a sports-type program. When the terminal 102 runs the application, an interface of the application is displayed on a screen of the terminal 102, and the virtual scene is displayed in the interface. In an embodiment, the terminal 102 may be a terminal used by a current player. The current player may control a virtual object in the virtual scene to perform an activity by using the terminal 102. The virtual object may be a virtual character, a virtual animal, a virtual animation character, or the like. The virtual object is implemented by using the three-dimensional model.

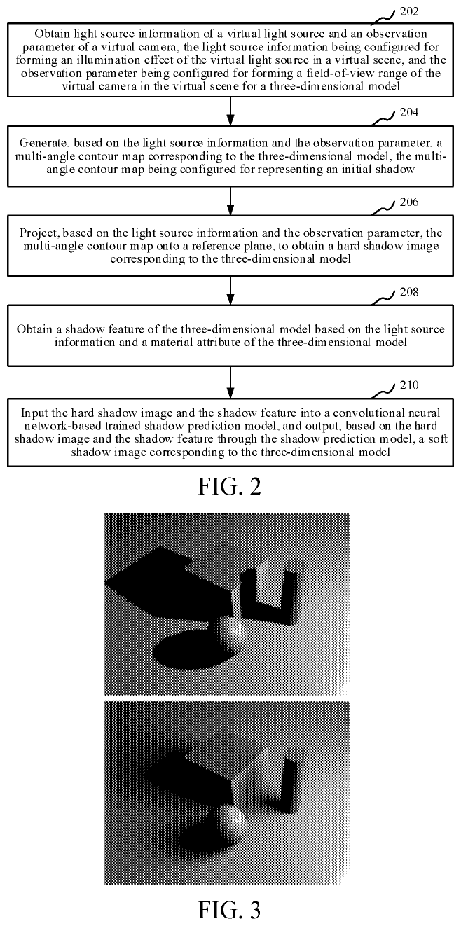

In an embodiment, as shown in FIG. 2, a shadow generation method for a three-dimensional model is provided. An example in which the method is performed by a computer device (for example, the terminal 102 or the server 104) in FIG. 1 is used for description. The method includes the following operations.

Operation 202: Obtain light source information of a virtual light source and an observation parameter of a virtual camera, the light source information being configured for forming an illumination effect of the virtual light source in a virtual scene, and the observation parameter being configured for forming a field-of-view range of the virtual camera in the virtual scene for a three-dimensional model.

In a three-dimensional graphic, the virtual light source is an important basis for generating a shadow. By simulating interaction between light and an object, the virtual light source determines intensity and a color of illumination on the object. Based on the virtual light source, high shadow quality can be presented, to significantly improve a texture and realism of a virtual scene picture. A type of the virtual light source usually includes ambient light, parallel light, a point light source, a spotlight, and the like. The light source information is configured for forming the illumination effect of the virtual light source in the virtual scene, and the light source information of the virtual light source includes at least one of the following content: a position of the light source; a direction of the light source; an angle of the light source; a near plane distance of the light source; a far plane distance of the light source; and an aspect ratio of the light source. The information determines an illumination manner, an illumination angle, and illumination intensity distribution of light illumination, and therefore affects generation of the shadow. A shape and a length of the shadow may be changed by adjusting the position and the angle of the virtual light source, to enhance a stereo perception and vividness of the three-dimensional model. Intensity of the virtual light source may further affect brightness of the shadow.

In three-dimensional graphic modeling, the virtual camera can simulate a real-world camera mechanism, and obtain a better effect during modeling, rendering, and animation production. The observation parameter is configured for forming a field-of-view range of the virtual camera in the virtual scene for a three-dimensional model, and the observation parameter of the virtual camera includes at least one of the following content: a position of the camera, that is, a position at which the virtual camera is located; a viewpoint of the camera; a field-of-view direction vector of the camera, that is, a ray pointing from the viewpoint of the camera to a target observation point; an up direction vector of the camera, designating an up direction of the virtual camera; an angle of the camera; a near plane distance of the camera; a far plane distance of the camera; and an aspect ratio of the camera.

The virtual scene is a virtual picture displayed when an application is run on a terminal. The virtual scene may be a simulated scene of a real scene, or may be a virtual scene by fusing a fictional scene and a real scene, or may be a fictional scene.

In a process of three-dimensional graphic modeling, a user may edit and set the light source information of the virtual light source and the observation parameter of the virtual camera in a view. Therefore, the computer device may obtain the light source information of the virtual light source and the observation parameter of the virtual camera from a setting parameter of the view.

Operation 204: Generate, based on the light source information and the observation parameter, a multi-angle contour map corresponding to the three-dimensional model, the multi-angle contour map being configured for representing an initial shadow.

The multi-angle contour map is an image formed by contour lines of the three-dimensional model from a plurality of different angles. The multi-angle contour map reflects a shape and a structure of the three-dimensional model, and may be configured for representing the initial shadow of the three-dimensional model. The computer device may sum, based on the light source information of the virtual light source and the observation parameter of the virtual camera, the contour lines of the three-dimensional model from different angles that are generated by a GPU-based renderer, to obtain the multi-angle contour map of diversified angles. Because rendering a contour shadow once on a GPU only needs low consumption, rendering can be completed within several milliseconds, and generation efficiency is high. With the multi-angle contour map, the multi-angle contour map is used as input data for soft shadow generation, that is, an initial shape of the shadow, so that an effect of a subsequently generated soft shadow image can be maintained, and an entire process of generating the soft shadow image can also be very efficient.

Operation 206: Project, based on the light source information and the observation parameter, the multi-angle contour map onto a reference plane, to obtain a hard shadow image corresponding to the three-dimensional model.

To obtain a spatial relationship between the three-dimensional model and the reference plane, after obtaining the multi-angle contour map, the computer device projects, based on the light source information and the observation parameter, the multi-angle contour map onto the reference plane, to obtain the hard shadow image corresponding to the three-dimensional model. The reference plane may be a simple horizontal plane or a virtual scene having a texture and a material. The three-dimensional model is placed on the reference plane.

Hardness of the shadow is an important factor affecting a shadow effect, and hardness of the shadow is related to a size and a shape of the virtual light source in the virtual scene. The shadow effect can be more vivid by adjusting hardness of the shadow. An edge of a hard shadow represented by the hard shadow image is very clear and has no gradient or blurring effect, and a gray scale of a shadow part is very uniform, so that the hard shadow image can reflect the shape and a contour of the three-dimensional model. An edge of a soft shadow represented by the soft shadow image has a gradient or blurring effect, and a gray scale of a shadow part is uneven. This can enhance a depth and vividness of the shadow. As shown in FIG. 3, FIG. 3 is a schematic diagram of a hard shadow and a soft shadow according to an embodiment. It can be learned that the hard shadow has a clear boundary, while the soft shadow has an uneven gray scale and shadow transition.

In an embodiment, after generating the hard shadow image, based on a shape and a material attribute of the reference plane, the computer device may further correct and optimize the hard shadow image, for example, eliminate aliasing and enhance shadow intensity.

Operation 208: Obtain a shadow feature of the three-dimensional model based on the light source information and a material attribute of the three-dimensional model.

A material of the three-dimensional model affects the shadow effect. Different materials have different light reflection and absorption capabilities, which affects brightness and a texture of the shadow. The material attribute includes at least one of the following content: diffuse reflectivity, specular reflectivity, roughness, and metallicity of a surface material of the three-dimensional model. In this embodiment of this disclosure, in consideration of the light source information of the virtual light source in the virtual scene and the material attribute of the three-dimensional model, which may affect the shape and intensity of the shadow, some features, that is, the shadow feature, are extracted therefrom. The hard shadow image of the three-dimensional model and the extracted shadow feature are combined to be used as an input needed for performing soft shadow prediction. That is, the soft shadow image is predicted based on the hard shadow image and the shadow feature by using a convolutional neural network model, to ensure quality of reconstructing the shadow of the three-dimensional model, and obtain a natural and vivid shadow effect.

Operation 210: Input the hard shadow image and the shadow feature into a convolutional neural network-based trained shadow prediction model, and output, based on the hard shadow image and the shadow feature through the shadow prediction model, a soft shadow image corresponding to the three-dimensional model.

The convolutional neural network-based shadow prediction model has a capability of predicting a soft shadow image based on a hard shadow image and a shadow feature. The shadow prediction model is obtained based on an initial convolutional neural network through continuous learning and training based on a training sample. The computer device inputs the hard shadow image and the shadow feature into the convolutional neural network-based trained shadow prediction model, and output, based on the hard shadow image and the shadow feature through the shadow prediction model, the soft shadow image corresponding to the three-dimensional model.

In related technology, rendering and processing of a shadow effect can be implemented by using complicated computer graphics based on a three-dimensional model and a virtual scene. However, this method has a problem of a large calculation amount and low shadow generation efficiency, and is difficult to be applied to real-time shadow reconstruction of the virtual scene. In this embodiment of this disclosure, the soft shadow image corresponding to the three-dimensional model can be rapidly generated through the shadow prediction model based on only the hard shadow image and the shadow feature. This method has high shadow generation efficiency, and can be applied to real-time shadow reconstruction of the virtual scene.

In an embodiment, further, the computer device runs a rendering program to perform rendering based on the soft shadow image, to achieve a high-quality, natural and vivid shadow effect. In an embodiment, rendering is combined with a bottom picture or a texture map of the virtual scene, so that a natural shadow effect can be efficiently displayed.

For example, the computer device may input the obtained soft shadow image as a shadow map into a resource set in a debugging module in a game engine, so that the game engine can generate a shadow effect corresponding to the three-dimensional model based on the soft shadow image. For example, the game engine performs overlay rendering on the soft shadow image and a scene texture corresponding to the virtual scene, and displays the shadow effect in the virtual scene.

The foregoing application scenario is an example for description, and the shadow generation method for the model may further be applied to a shadow generation process of a model in another virtual scene. This is not limited herein.

According to the foregoing shadow generation method for a three-dimensional model, light source information of a virtual light source and an observation parameter of a virtual camera are obtained, the light source information being configured for representing an illumination effect of the virtual light source in a virtual scene, and the observation parameter being configured for representing a field-of-view range of the virtual camera in the virtual scene for a three-dimensional model. A multi-angle contour map corresponding to the three-dimensional model is generated based on the light source information and the observation parameter, the multi-angle contour map being configured for representing an initial shadow. The multi-angle contour map is projected onto a reference plane based on the light source information and the observation parameter, to obtain a hard shadow image corresponding to the three-dimensional model. A shadow feature of the three-dimensional model is obtained based on the light source information and a material attribute of the three-dimensional model. The hard shadow image and the shadow feature are input into a convolutional neural network-based trained shadow prediction model, and a soft shadow image corresponding to the three-dimensional model is output based on the hard shadow image and the shadow feature through the shadow prediction model. The soft shadow image may be configured for generating a more real and natural soft shadow effect. In other words, a single multi-angle contour map generation process with low consumption is required, and then the hard shadow image of the three-dimensional model is generated based on the multi-angle contour map. Therefore, a shadow effect of the three-dimensional model can be efficiently generated based on the hard shadow image and the shadow feature, so that a data processing volume during shadow generation is reduced, and shadow generation efficiency is improved.

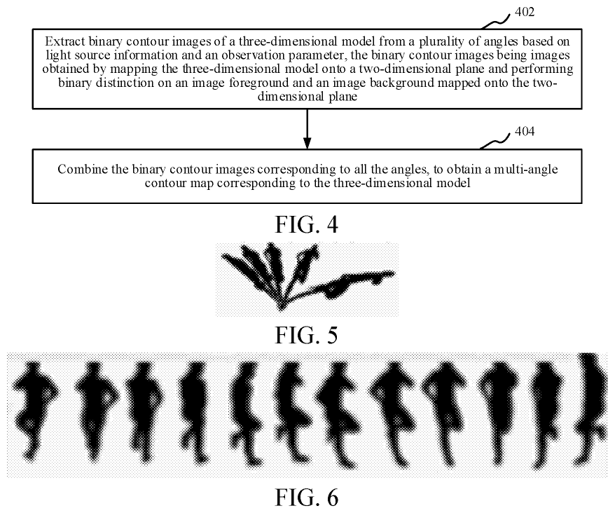

In an embodiment, as shown in FIG. 4, the generating, based on light source information and an observation parameter, a multi-angle contour map corresponding to a three-dimensional model includes the following operations.

Operation 402: Extract binary contour images of the three-dimensional model from a plurality of angles based on the light source information and the observation parameter, the binary contour images being images obtained by mapping the three-dimensional model onto a two-dimensional plane and performing binary distinction on an image foreground and an image background mapped onto the two-dimensional plane.

The binary contour images are obtained by rendering the three-dimensional model to obtain two-dimensional images, and then extracting edge contour lines from the two-dimensional images. The computer device may map the three-dimensional model onto the two-dimensional plane from a plurality of different angles of the three-dimensional model, to obtain the two-dimensional images, and then extract the edge contour lines from the two-dimensional images, that is, perform binary distinction on the image foreground and the image background, thereby obtaining the binary contour images of the three-dimensional model from the plurality of different angles. As shown in FIG. 5, FIG. 5 is a schematic diagram of binary contour images corresponding to a three-dimensional model from a plurality of different angles according to an embodiment.

Operation 404: Combine the binary contour images corresponding to all the angles, to obtain the multi-angle contour map corresponding to the three-dimensional model.

In an embodiment, the combining the binary contour images corresponding to all the angles, to obtain the multi-angle contour map corresponding to the three-dimensional model includes: performing a logical OR operation on the binary contour images corresponding to all the angles, to obtain the multi-angle contour map corresponding to the three-dimensional model.

As shown in FIG. 6, FIG. 6 is a schematic diagram of a multi-angle contour map corresponding to a three-dimensional model according to an embodiment. Referring to FIG. 6, FIG. 6 includes contour maps of the three-dimensional model from different angles. A three-dimensional model part is a black region, and a background part is a white region.

In this embodiment, edge contour lines of the three-dimensional model are extracted from different angles, and these edge contour lines are combined into a binary image, which can accurately reflect the shape of the three-dimensional model, and may be used as input data for shadow generation, thereby facilitating subsequent generation of a high-quality soft shadow image.

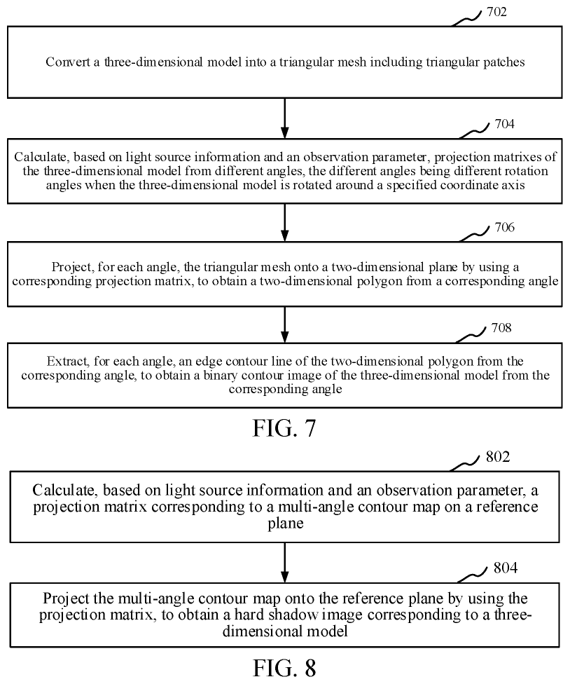

In an embodiment, as shown in FIG. 7, the extracting binary contour images of the three-dimensional model from a plurality of angles based on the light source information and the observation parameter includes the following operations.

Operation 702: Convert the three-dimensional model into a triangular mesh including triangular patches.

The triangular patch is a two-dimensional geometric figure including three vertexes and three edges. Each of the edges connects two vertexes, to form a closed triangle. The triangular patch is generally configured for describing a surface of a three-dimensional object. A complex shape may be constructed by combining a large number of adjacent triangular patches. The triangular mesh including triangular patches may be configured for simulating a surface of a complex object. To facilitate subsequent projection transformation and image processing, the computer device may first convert the three-dimensional model into a triangular mesh, that is, a mesh structure formed by a series of triangular patches. The structure can well maintain the shape and details of the three-dimensional model, and also facilitate a geometrical operation and rendering.

Operation 704: Calculate, based on the light source information and the observation parameter, projection matrixes of the three-dimensional model from different angles, the different angles being different rotation angles when the three-dimensional model is rotated around a specified coordinate axis.

The specified coordinate axis may be a longitudinal axis of the three-dimensional model. The three-dimensional model may be rotated around the longitudinal axis of the three-dimensional model, and the projection matrixes corresponding to different rotation angles in a rotation process may be calculated based on the light source information and the observation parameter. The projection matrixes may reflect spatial relationships between the three-dimensional model and the two-dimensional plane from different angles.

Operation 706: Project, for each angle, the triangular mesh onto the two-dimensional plane by using a corresponding projection matrix, to obtain a two-dimensional polygon from a corresponding angle.

Operation 708: Extract, for each angle, an edge contour line of the two-dimensional polygon from the corresponding angle, to obtain the binary contour image of the three-dimensional model from the corresponding angle.

The computer device may extract an edge of the two-dimensional polygon by using an image processing algorithm, to obtain a binary image. The binary image may reflect an edge contour of the three-dimensional model, and therefore is referred to as the binary contour image.

In this embodiment, the edge contour lines of the three-dimensional model are extracted from different angles, so that the shape of the three-dimensional model can be accurately reflected.

In an embodiment, operation 702 of converting the three-dimensional model into a triangular mesh including triangular patches includes: obtaining a vertex set and a triangular patch set of the three-dimensional model, each triangular patch in the triangular patch set being represented by three vertex indexes, and all three vertexes identified by the three vertex indexes belonging to the vertex set; and generating the triangular mesh based on the vertex set and the triangular patch set.

Vertexes and triangular patches corresponding to a three-dimensional model are known. A vertex set and a triangular patch set are respectively represented by V and F. V is an n×3 matrix, each row representing coordinates (x, y, z) of a vertex. F is an m×3 matrix, each row representing three vertex indexes, that is, vertex identifiers or vertex sequence numbers, of a triangular patch. A triangular mesh M generated based on V and F needs to meet the following conditions. A vertex set of the triangular mesh M is the same as V, that is, M has n vertexes, and coordinates of each vertex are the same as a corresponding row in V A triangular patch set of M is the same as F, that is, M has m triangular patches, and three vertexes of each triangular patch are the same as corresponding rows in F. Each triangular patch of M is a triangle, that is, each row in F is three different integers, and the three integers each range from 1 to n. Each triangular patch of M is anticlockwise, that is, each row (i, j, k) in F satisfies Vi×Vj·Vk>0, where i, j, and k represent three different vertexes, x represents vector cross multiplication, and · represents vector dot multiplication.

In an embodiment, the generating the triangular mesh based on the vertex set and the triangular patch set includes: generating a corresponding normal vector for each triangular patch in the triangular patch set, the normal vector being a unit vector perpendicular to the triangular patch; determining, based on a direction vector of a light source and the normal vector, whether a patch direction of the triangular patch is an anticlockwise direction, the patch direction being determined by the three vertexes forming the triangular patch; exchanging, when the patch direction of the triangular patch is not the anticlockwise direction, an order of latter two vertexes of the triangular patch, to obtain a triangular patch of which a patch direction is the anticlockwise direction; and storing the vertex set and the triangular patch of the anticlockwise direction into a triangular mesh object, to obtain the triangular mesh corresponding to the three-dimensional model.

In some examples, first, the computer device calculates the normal vector corresponding to each triangular patch, that is, the unit vector perpendicular to the triangular patch, which may be calculated by using coordinates of the three vertexes. A formula is as follows:

$$N\_ijk = \frac{( Vi - Vj ) \times ( Vj - Vk )}{‖ ( Vi - Vj ) \times ( Vj - Vk ) ‖} ;$$

Vi, Vj, and Vk represent three-dimensional coordinates of the three vertexes i, j, and k, and ∥⋅∥ represents a modulus length of a vector, that is, a Euclidean distance.

Next, the computer device determines the direction of each triangular patch, that is, whether the direction is the anticlockwise direction. This may be determined by using the position and the direction of the virtual light source. A formula is as follows:

$$D\_ijk = N\_ijk \cdot L$$

L represents the direction vector of the virtual light source. If D_ijk>0, it represents that the triangular patch (i, j, k) is anticlockwise; otherwise, if D_ijk≤0, the order of the vertex j and the vertex k are interchanged, so that the triangular patch becomes anticlockwise.

Then, the computer device stores information of the vertexes and the triangular patches into a triangular mesh object, which may be implemented by using some data structures, for example, an adjacency list and a half-edge structure. In this case, a triangular mesh object M is generated, which can store and access the information of the vertexes and the triangular patches.

In this embodiment, the three-dimensional model is converted into the triangular mesh formed by the triangular patches, so that a surface form of the three-dimensional model can be well simulated, thereby facilitating a subsequent geometrical operation and rendering.

In an embodiment, as shown in FIG. 8, operation 206 of projecting, based on the light source information and the observation parameter, the multi-angle contour map onto a reference plane, to obtain a hard shadow image corresponding to the three-dimensional model includes the following operations.

Operation 802: Calculate, based on the light source information and the observation parameter, a projection matrix corresponding to the multi-angle contour map on the reference plane.

The reference plane is a preset plane, for example, may be a ground in the virtual scene. The computer device may calculate, based on the light source information and the observation parameter, the projection matrix corresponding to the multi-angle contour map on the reference plane. The projection matrix may be configured for reflecting the spatial relationship between the three-dimensional model and the reference plane.

Operation 804: Project the multi-angle contour map onto the reference plane by using the projection matrix, to obtain the hard shadow image corresponding to the three-dimensional model.

The computer device may project the multi-angle contour map onto the reference plane based on the projection matrix corresponding to the multi-angle contour map on the reference plane. By using the method based on projection transformation and image processing, the hard shadow image of the three-dimensional model can be rapidly generated based on the multi-angle contour map without complex rendering and processing on the three-dimensional model and the virtual scene, and only a binary image may be needed as input, which is efficient and convenient.

In an embodiment, operation 802 of calculating, based on the light source information and the observation parameter, a projection matrix corresponding to the multi-angle contour map on the reference plane includes: calculating, based on the observation parameter, a first transformation matrix configured for converting two-dimensional coordinates of a pixel in the multi-angle contour map into three-dimensional coordinates in a world coordinate system; calculating, based on the light source information, a second transformation matrix configured for converting the three-dimensional coordinates into projection coordinates on the reference plane; and calculating the projection matrix based on the first transformation matrix and the second transformation matrix.

The project the multi-angle contour map onto the reference plane, a projection matrix needs to be calculated. The projection matrix may map each pixel in the multi-angle contour map to a position on the reference plane. It is assumed that the reference plane is a plane, and an equation thereof is ax+by +cz+d=0, where a, b, c, and d are known constants. Assuming that both the light source information of the virtual light source and the observation parameter of the virtual camera are known, a 4×4 projection matrix P is calculated based on these parameters, and the projection matrix P needs to meet the following conditions.

For any pixel (u, v) in the multi-angle contour map, corresponding three-dimensional coordinates are (x, y, z, 1), where x, y, and z are calculated based on the observation parameter of the virtual camera.

Projection coordinates of the three-dimensional coordinates (x, y, z, 1) on the reference plane are (x′, y′, z′, 1), where x′, y′, and z′ are all calculated based on the light source information of the virtual light source.

That is, the projection matrix P may project any pixel in the multi-angle contour map onto the reference plane.

The first transformation matrix is configured for converting the multi-angle contour map located in a camera coordinate system into the world coordinate system, and the second transformation matrix is configured for converting the world coordinate system into a projection coordinate system corresponding to the reference plane.

In an embodiment, the calculating the projection matrix based on the first transformation matrix and the second transformation matrix includes: multiplying the second transformation matrix by the first transformation matrix, to obtain the projection matrix.

In an embodiment, the calculating, based on the observation parameter, a first transformation matrix configured for converting two-dimensional coordinates of a pixel in the multi-angle contour map into three-dimensional coordinates in a world coordinate system includes: calculating a front orthogonal basis vector of the virtual camera based on a field-of-view direction vector of the virtual camera; calculating a right orthogonal basis vector of the virtual camera based on the front orthogonal basis vector and an up vector of the virtual camera; calculating an up orthogonal basis vector of the virtual camera based on the right orthogonal basis vector and the front orthogonal basis vector, the front orthogonal basis vector, the right orthogonal basis vector, and the up orthogonal basis vector of the virtual camera forming a camera coordinate system of the virtual camera; and calculating the first transformation matrix based on a position of the virtual camera and the front orthogonal basis vector, the right orthogonal basis vector, and the up orthogonal basis vector of the virtual camera, the first transformation matrix being configured for converting the camera coordinate system into the world coordinate system.

To calculate the projection matrix, the three-dimensional coordinates (x, y, z, 1) corresponding to each pixel in the multi-angle contour map are first calculated, and may be calculated by using the observation parameter of the virtual camera. Assuming that the position of the virtual camera is (Cx, Cy, Cz), the direction of the virtual camera is (Dx, Dy, Dz), the up vector of the virtual camera is (Ux, Uy, Uz), the angle of the virtual camera is θ, the near plane distance of the virtual camera is n, the far plane distance of the virtual camera is f, and the aspect ratio of the virtual camera is r, a 4×4 first transformation matrix V is calculated based on the foregoing parameters, and the first transformation matrix V meets the following conditions.

For any pixel (u, v) in the binary image, corresponding three-dimensional coordinates are (x, y, z, 1), where x, y, and z satisfy the following formula:

$$[ \begin{matrix}x \\ y \\ z \\ 1\end{matrix} ] = [ \begin{matrix}n tan ( \frac{θ}{2} ) \frac{u}{w} \\ n tan ( \frac{θ}{2} ) \frac{v}{h} \\ - n \\ 1\end{matrix} ] ;$$

and V satisfies (x, y, z, 1)=V(Cx, Cy, Cz, 1), that is, the first transformation matrix V may convert the position coordinates of the camera into three-dimensional coordinates. w and h are a width and a height of the multi-angle contour map, u and v are horizontal and vertical coordinates of the pixel, and tan(θ/2) is a tangent of a half-vertex angle of a view frustum of the virtual camera. To calculate the matrix V, three orthogonal basis vectors of the virtual camera, that is, the right orthogonal basis vector, the up orthogonal basis vector, and the front orthogonal basis vector of the virtual camera, are first calculated, which are respectively R=(Rₓ, R_{y}, R_{z}), U=(Uₓ, U_{y}, U_{z}), F=(Fₓ, F_{y}, F_{z}), which satisfy the following formula:

$$F = \frac{D}{‖ D ‖} \\ R = \frac{F \times U}{‖ F \times U ‖} \\ U = R \times F$$

x represents vector cross multiplication, represents a modulus length of a vector, and D=(Dₓ, D_{y}, D_{z}) is the field-of-view direction vector of the virtual camera. The first transformation matrix V may be calculated based on the position of the virtual camera and the three orthogonal basis vectors, and a formula is as follows:

$$V = [ \begin{matrix}{R}_{x} & {U}_{x} & - {F}_{x} & - {C}_{x} \\ {R}_{y} & {U}_{y} & - {F}_{y} & - {C}_{y} \\ {R}_{z} & {U}_{z} & - {F}_{z} & - {C}_{z} \\ 0 & 0 & 0 & 1\end{matrix} ] .$$

In an embodiment, the light source information includes a position of the virtual light source and a light source direction vector, and the calculating, based on the light source information, a second transformation matrix configured for converting the three-dimensional coordinates into projection coordinates on the reference plane includes: calculating a front orthogonal basis vector of the virtual light source based on a light source direction vector of the virtual light source; calculating a right orthogonal basis vector of the virtual light source based on the right orthogonal basis vector of the virtual camera; calculating an up orthogonal basis vector of the virtual light source based on the front orthogonal basis vector of the virtual light source and the right orthogonal basis vector of the virtual light source, the front orthogonal basis vector, the right orthogonal basis vector, and the up orthogonal basis vector of the virtual light source forming a light source coordinate system of the virtual light source; and calculating the second transformation matrix based on the position of the virtual light source and the front orthogonal basis vector, the right orthogonal basis vector, and the up orthogonal basis vector of the virtual light source, the second transformation matrix being configured for converting the world coordinate system into a projection coordinate system corresponding to the reference plane.

The projection coordinates (x′, y′, z′, 1) of the three-dimensional coordinates on the reference plane may be calculated based on the light source information of the virtual light source. Assuming that the position of the virtual light source is (Lx, Ly, Lz), the light source direction vector of the virtual light source is (Sx, Sy, Sz), the angle of the virtual light source is φ, the near plane distance of the virtual light source is n′, the far plane distance of the virtual light source is f′, and the aspect ratio of the virtual light source is r′, a 4×4 second transformation matrix P′ is calculated based on these parameters, and the second transformation matrix P′ meets the following conditions.

Projection coordinates of the three-dimensional coordinates (x, y, z, 1) on the reference plane are (x′, y′, z′, 1), where x′, y′, and z′ satisfy the following formula:

$$[ \begin{matrix}{x}^{′} \\ {y}^{′} \\ {z}^{′} \\ 1\end{matrix} ] = [ \begin{matrix}{n}^{′} tan ( \frac{ϕ}{2} ) \frac{x}{z} \\ {n}^{′} tan ( \frac{ϕ}{2} ) \frac{y}{z} \\ - {n}^{′} \\ 1\end{matrix} ] ;$$

tan(φ/2) represents a tangent of a half-vertex angle of a view frustum of the virtual light source. The second transformation matrix P′ satisfies that (x′, y′, z′, 1)=P′(x, y, z, 1), that is, P′ may be used to convert the three-dimensional coordinates into the projection coordinates.

To calculate P′, three orthogonal basis vectors of the virtual light source, that is, the right orthogonal basis vector, the up orthogonal basis vector, and the front orthogonal basis vector of the virtual light source, need to be first calculated, which are respectively R′=(Rₓ′, R_{y}′, R_{z}′), U′=(Uₓ′, U_{y}′, U_{z}′), and F′=(Fₓ′, F_{y}′, F_{z}′), which satisfy the following formulas:

$${F}^{′} = \frac{S}{‖ S ‖} \\ {R}^{′} = \frac{R}{‖ R ‖} \\ {U}^{′} = {R}^{′} \times {F}^{′}$$

S=(Sx, Sy, Sz) is the light source direction vector of the virtual light source.

Next, the second transformation matrix P′ may be calculated based on the position of the virtual light source and the three orthogonal basis vectors, and a formula is as follows:

$${P}^{′} = [ \begin{matrix}{R}_{x}^{′} & {U}_{x}^{′} & - {F}_{x}^{′} & - {L}_{x} \\ {R}_{y}^{′} & {U}_{y}^{′} & - {F}_{y}^{′} & - {L}_{y} \\ {R}_{z}^{′} & {U}_{z}^{′} & - {F}_{z}^{′} & - {L}_{z} \\ 0 & 0 & 0 & 1\end{matrix} ] ;$$

The first transformation matrix V and the second transformation matrix P′ are multiplied, to obtain a final projection matrix P, and a formula is as follows:

$$P = {P}^{′} V$$

Each pixel in the multi-angle contour map may be mapped to a position on the reference plane based on the projection matrix P, to generate the hard shadow image.

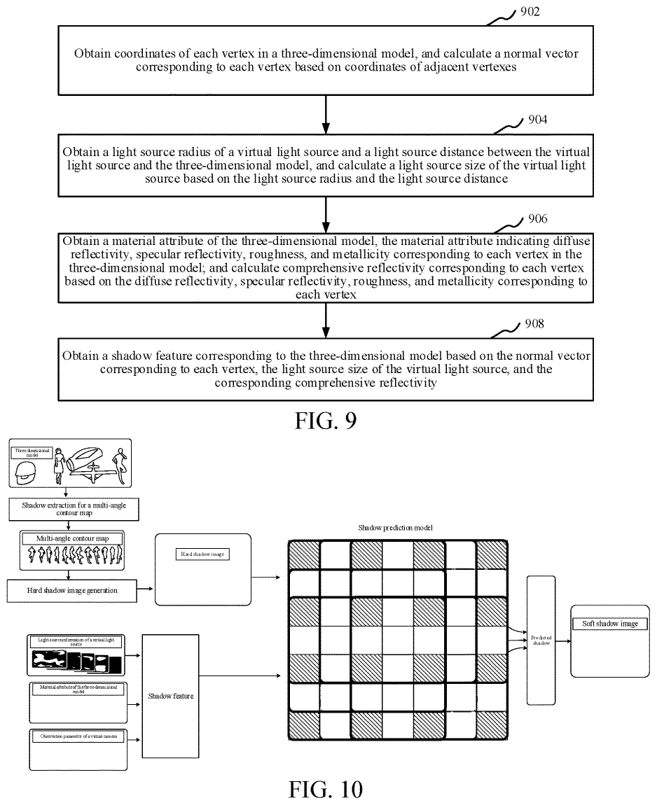

In an embodiment, as shown in FIG. 9, operation 208 of obtaining a shadow feature of the three-dimensional model based on the light source information and a material attribute of the three-dimensional model includes the following operations.

Operation 902: Obtain coordinates of each vertex in the three-dimensional model, and calculate a normal vector corresponding to each vertex based on coordinates of adjacent vertexes.

Assuming that the vertex set of the three-dimensional model is represented by C, C is an n×3 matrix, and each row represents x, y, and z coordinates of a vertex, the normal vector of each vertex may be calculated based on the coordinates of each vertex in the vertex set. Normal vectors of all vertexes may reflect the shape and details of the three-dimensional model, and incident and reflected angles of light. Therefore, using the normal vector as the shadow feature of the three-dimensional model may help improve quality of the generated soft shadow image.

The adjacent vertexes may be found based on the vertex set corresponding to the three-dimensional model, and the normal vector of each vertex may be calculated based on the coordinates of the adjacent vertexes. A formula is as follows:

$$Ni = {\sum }_{j ∈ N ( i )} \frac{( Ci - Cj ) \times ( Ci - Ck )}{‖ ( Ci - Cj ) \times ( Ci - Ck ) ‖} ;$$

x represents vector cross multiplication, ∥⋅∥ represents a modulus length of a vector, N(i) represents a neighbor set of the vertex i, and k represents any vertex not equal to i or j. The normal vectors of all vertexes may be stored by using an n×3 matrix N, and each row represents a normal vector of a vertex.

Operation 904: Obtain a light source radius of the virtual light source and a light source distance between the virtual light source and the three-dimensional model, and calculate a light source size of the virtual light source based on the light source radius and the light source distance.

The light source size of the virtual light source may affect a blur degree of the shadow. A larger light source indicates a blurrier shadow. Therefore, the light source size of the virtual light source is also a factor that may affect shadow generation. The computer device may calculate the light source size of the virtual light source based on the light source radius of the virtual light source and the light source distance between the virtual light source and the three-dimensional model, and a formula is as follows:

$$S = 2 r / d ;$$

r represents a radius or a width of the light source, d represents the light source distance between the light source and the three-dimensional model, and S represents the light source size of the virtual light source, that is, the scalar S may store the light source size of the virtual light source.

Operation 906: Obtain the material attribute of the three-dimensional model, the material attribute indicating diffuse reflectivity, specular reflectivity, roughness, and metallicity corresponding to each vertex in the three-dimensional model; and calculate comprehensive reflectivity corresponding to each vertex based on the diffuse reflectivity, specular reflectivity, roughness, and metallicity corresponding to each vertex.

The reflectivity refers to an ability of a material to reflect light, and may affect brightness of the shadow. Higher reflectivity indicates a darker shadow. The computer device may calculate the reflectivity of each vertex based on the diffuse reflectivity, specular reflectivity, roughness, and metallicity of the surface material of the three-dimensional model. A formula is as follows:

$$Ri = {M}_{i}^{1} + {M}_{i}^{2} ( 1 - {M}_{i}^{1} ) {( 1 - cos ( θ ) )}^{5} ;$$

M is an n×4 matrix, each row represents diffuse reflectivity, specular reflectivity, roughness, and metallicity of a vertex,

$${M}_{i}^{1}$$

is the diffuse reflectivity of the vertex i,

$${M}_{i}^{2}$$

is the specular reflectivity of the vertex i, θ is an included angle between a light beam of the virtual light source and a normal vector corresponding to the vertex i, and Ri is reflectivity of the vertex i. The computer device may store reflectivity information of all vertexes by using an n×1 vector R, and each row represents reflectivity of a vertex.

Operation 908: Obtain the shadow feature corresponding to the three-dimensional model based on the normal vector corresponding to each vertex, the light source size of the virtual light source, and the corresponding comprehensive reflectivity.

In an embodiment, to jointly use the information and the hard shadow image as an input of the shadow prediction model, the computer device may further convert the information into information having a resolution and a format the same as those of the hard shadow image, that is, a w×h×c tensor, where w and h are a width and a height of the hard shadow image, and c is a quantity of channels. In an embodiment, the computer device may map the feature from vertex space to pixel space by using some methods such as interpolation or resampling. This is not limited in this embodiment of this disclosure. For example, it is assumed that there is a function F that may convert the information into the information having the resolution and the format the same as those of the hard shadow image. A formula is as follows:

$$Fi = F ( Ni , S , Ri )$$

Ni is the normal vector of the vertex i, S is the light source size of the virtual light source, Ri is reflectivity information of the vertex i, and Fi is a shadow feature map of a pixel i. The computer device may store shadow features of all pixels by using a w×h×c tensor F, to complete shadow feature extraction.

In this embodiment, to generate the soft shadow image, some factors affecting the shape and intensity of the shadow, for example, the normal vector of the three-dimensional model, the light source size of the virtual light source, and the material attribute of the three-dimensional model, are considered. Some features are extracted based on these factors, and are used with the hard shadow image as an input to be provided to the convolutional neural network-based shadow prediction model, so that the quality of the generated soft shadow image can be improved.

In an embodiment, operation 210 of inputting the hard shadow image and the shadow feature into a convolutional neural network-based trained shadow prediction model, and outputting, based on the hard shadow image and the shadow feature through the shadow prediction model, a soft shadow image corresponding to the three-dimensional model includes the following operations: mapping the shadow feature from vertex space to pixel space, to obtain a shadow feature map having a data size the same as that of the hard shadow image, concatenating the hard shadow image and the shadow feature map based on a channel by using an input layer of the shadow prediction model, to obtain an input tensor, and inputting the input tensor into the convolutional neural network-based trained shadow prediction model; successively performing feature encoding and feature downsampling on the input tensor through an encoder of the shadow prediction model, to obtain a high-resolution encoding feature, the encoder including a plurality of atrous convolutional layers and pooling layers that are alternately connected in sequence; successively performing feature decoding and feature upsampling on the high-resolution encoding feature through a decoder of the shadow prediction model, to obtain a low-resolution decoding feature, the decoder including a plurality of atrous convolutional layers and upsampling layers that are alternately connected in sequence; and converting the low-resolution decoding feature into an output tensor having a data size the same as that of the hard shadow image by using an output layer of the shadow prediction model, the output tensor being the soft shadow image corresponding to the three-dimensional model.

The input layer of the shadow prediction model receives the hard shadow image and the shadow feature map as input, and concatenate the hard shadow image and the shadow feature map into a w×h×(c+1) tensor, where w and h are the width and the height of the hard shadow image, c is the quantity of channels of the feature, and +1 is a quantity of channels of the hard shadow image.

The encoder of the shadow prediction model includes a plurality of atrous convolutional layers and pooling layers, and has functions of gradually downsampling a tensor of the input layer, extracting a high-level feature, and increasing a size of a receptive field. Each atrous convolutional layer may cover a different spatial range by using different voidage, so that diversity and flexibility of convolution are improved. A non-linear expression capability can be enhanced by using batch normalization and an activation function.

The decoder of the shadow prediction model includes a plurality of atrous convolutional layers and upsampling layers, and has functions of gradually upsampling a tensor of the encoder, restoring an original resolution, and reserving the high-level feature. By using voidage opposite to that of the encoder, each atrous convolutional layer can match a corresponding layer of the encoder, to implement skip connection, and integrating features of a low level and a high level. The non-linear expression capability is enhanced by using batch normalization and the activation function.

The output layer of the shadow prediction model is an atrous convolutional layer, and has a function of converting a tensor of the decoder into a w×h×1 tensor, that is, the soft shadow image. A convolution kernel of which voidage is 1 is used, so that the output layer can maintain a resolution the same as that of the input layer, and a hyperbolic tangent function is used as the activation function, to limit an output value between −1 and 1, so as to represent the intensity of the shadow.

The hard shadow image and the shadow feature map are concatenated based on the channel, and then input to the trained shadow prediction model, so that the soft shadow image corresponding to the three-dimensional model may be directly output.

In an embodiment, training operations for the convolutional neural network-based shadow prediction model include the following operations: obtaining a plurality of training samples, each of the training samples including the hard shadow image and the shadow feature corresponding to the three-dimensional model, and a sample soft shadow image corresponding to the hard shadow image; inputting, for each of the training samples, the corresponding shadow feature map into an initial shadow prediction model, and outputting a corresponding predicted soft shadow image through the shadow prediction model; calculating, for each of the training samples, a difference between the corresponding predicted soft shadow image and the sample soft shadow image, and constructing a loss function based on the differences corresponding to the plurality of samples; and updating the shadow prediction model based on the loss function.

In this embodiment, to train the foregoing shadow prediction model, training sample data, that is, the hard shadow image and the shadow feature corresponding to the three-dimensional model, and the sample soft shadow image corresponding to the hard shadow image need to be prepared. The hard shadow image and the shadow feature corresponding to the three-dimensional model are used as an input of the shadow prediction model, and the sample soft shadow image is used to be compared with the predicted soft shadow image output by the model, to update the shadow prediction model. The sample soft shadow image corresponding to the hard shadow image corresponding to the three-dimensional model may be generated by using some soft shadow generation algorithms. In a training process, some data enhancement methods, for example, rotation, zooming, cutting, and noise, may further be used to increase diversity and robustness of the training data.

Input data of the plurality of training samples and the sample soft shadow image are respectively represented by X and Y. X is a n×w×h×(c+1) tensor, each row represents input data of a training sample, that is, a combination of a hard shadow image and a shadow feature, Y is a n×w×h×1 tensor, and each row represents a soft shadow image in a training sample. A model parameter of the shadow prediction model based on an atrous convolutional neural network may be optimized based on X and Y, so that X may be mapped to Y as much as possible, that is, the following loss function is minimized:

$$L = {{\sum }_{i = 1}}^{n} {‖ Yi - F ( Xi ) ‖}^{2} ;$$

where F represents the shadow prediction model based on an atrous convolutional neural network, and L represents the loss function. The model parameter of the shadow prediction model may be updated by using some optimization algorithms, for example, stochastic gradient descent and Adam, to reduce a value of the loss function. It is assumed that there is a function O that may update the model parameter of the shadow prediction model based on X and Y A formula is as follows:

$$O ( X , Y ) = arg min FL ;$$

where O represents an optimization function, and argminF represents finding, in all possible values of F, a value of F that minimises L.

The loss function may be a mean square error, and may measure the difference between the outputted predicted soft shadow image and the sample soft shadow image. A formula is as follows:

$$L = \frac{1}{wh} {\sum }_{i = 1}^{w} {\sum }_{j = 1}^{h} {( {O}_{i , j} - {T}_{i , j} )}^{2}$$

Oij is a value of a pixel in an i^{th} row and a j^{th} column of the outputted predicted soft shadow image, Tij is a value of a pixel in an i^{th} row and a j^{th} column of the sample soft shadow image, and L is the value of the loss function.

In a specific embodiment, the shadow generation method for a three-dimensional model may be performed by the computer device, and includes the following operations:
1. obtaining light source information of a virtual light source and an observation parameter of a virtual camera, the light source information being configured for forming an illumination effect of the virtual light source in a virtual scene, and the observation parameter being configured for forming a field-of-view range of the virtual camera in the virtual scene for a three-dimensional model;
2. converting the three-dimensional model into a triangular mesh including triangular patches, and calculating, based on the light source information and the observation parameter, projection matrixes of the three-dimensional model from different angles, the different angles being different rotation angles when the three-dimensional model is rotated around a specified coordinate axis;
3. projecting, for each angle, the triangular mesh onto the two-dimensional plane by using a corresponding projection matrix, to obtain a two-dimensional polygon from a corresponding angle;
4. extracting, for each angle, an edge contour line of the two-dimensional polygon from the corresponding angle, to obtain the binary contour image of the three-dimensional model from the corresponding angle, the binary contour images being images obtained by mapping the three-dimensional model onto a two-dimensional plane and performing binary distinction on an image foreground and an image background mapped onto the two-dimensional plane;
5. performing a logical OR operation on the binary contour images corresponding to all the angles, to obtain the multi-angle contour map corresponding to the three-dimensional model, the multi-angle contour map being configured for representing an initial shadow;
6. calculating, based on the observation parameter, a first transformation matrix configured for converting two-dimensional coordinates of a pixel in the multi-angle contour map into three-dimensional coordinates in a world coordinate system; calculating, based on the light source information, a second transformation matrix configured for converting the three-dimensional coordinates into projection coordinates on the reference plane; and multiplying the second transformation matrix by the first transformation matrix, to obtain the projection matrix;
7. projecting the multi-angle contour map onto the reference plane by using the projection matrix, to obtain the hard shadow image corresponding to the three-dimensional model;
8. obtaining coordinates of each vertex in the three-dimensional model, and calculating a normal vector corresponding to each vertex based on coordinates of adjacent vertexes; obtaining a light source radius of the virtual light source and a light source distance between the virtual light source and the three-dimensional model, and calculating a light source size of the virtual light source based on the light source radius and the light source distance; obtaining the material attribute of the three-dimensional model, the material attribute indicating diffuse reflectivity, specular reflectivity, roughness, and metallicity corresponding to each vertex in the three-dimensional model; and calculating comprehensive reflectivity corresponding to each vertex based on the diffuse reflectivity, specular reflectivity, roughness, and metallicity corresponding to each vertex; and obtaining the shadow feature corresponding to the three-dimensional model based on the normal vector corresponding to each vertex, the light source size of the virtual light source, and the corresponding comprehensive reflectivity; and
9. inputting the hard shadow image and the shadow feature into a convolutional neural network-based trained shadow prediction model, and outputting, based on the hard shadow image and the shadow feature through the shadow prediction model, a soft shadow image corresponding to the three-dimensional model.

As shown in FIG. 10, FIG. 10 is a schematic diagram of a framework of a shadow generation method for a three-dimensional model according to an embodiment. Referring to FIG. 10, the schematic diagram of a framework includes a plurality of modules. First, shadow extraction for a multi-angle contour map is performed: for a three-dimensional model, contour maps thereof are rendered from different angles, and then the contour maps are combined into a binary image, that is, the multi-angle contour map, where a model part is black and a background part is white. The binary image may be used as an initial shape of a shadow. Secondly, hard shadow image generation is performed: the multi-angle contour map is projected onto a reference plane based on light source information and an observation parameter of a camera, to obtain a hard shadow image. The image may be used as initial intensity of the shadow. Then, a shadow prediction model is designed: a model based on an atrous convolutional neural network is designed. An input is the hard shadow image and a shadow feature corresponding to the three-dimensional model, and an output is a soft shadow image. An objective of the network is to learn how to generate a more real and natural soft shadow effect based on a shape of the model, the light source information of a virtual light source, the observation parameter of the virtual camera, and a material attribute of the three-dimensional model. Finally, soft shadow image generation is performed: The hard shadow image of each three-dimensional model is converted by using an improved atrous convolutional neural network, to obtain a soft shadow image. The image may be used as a final result of the shadow, and is fused with a virtual scene.

According to the shadow generation method for a three-dimensional model, rapid shadow image generation can be implemented by relying on only a black and white map or texture of the three-dimensional model in some examples, and a corresponding shadow image is also black and white. Relying on only the shadow image, a rendering effect can be achieved in combination with rendering, and a shadow effect can be efficiently presented and rendered in combination with a rendering program and a bottom picture or texture and color overlay.

Although all the operations in the flowcharts involved in the embodiments are displayed sequentially as indicated by the arrows, the operations are not necessarily executed sequentially as indicated by the arrows. Unless specified in this specification, there is no strict sequence limitation on the execution of the operations, and the operations may be performed in another sequence. In addition, at least some operations in the flowcharts involved in the foregoing embodiments may include a plurality of operations or a plurality of stages, and the operations or stages are not necessarily performed at the same moment, and may be performed at different moments. The operations or stages are not necessarily performed in sequence, and may be performed in turns or alternately with other operations, or at least a part of operations or stages in the other operations.

An aspect of the disclosure further provides a shadow generation apparatus for a three-dimensional model for implementing the foregoing shadow generation method for a three-dimensional model. An implementation solution provided by the apparatus for resolving the problem is similar to the implementation solution described in the foregoing method. Therefore, for specific limitations on one or more embodiments of the shadow generation apparatus for a three-dimensional model provided below, reference may be made to the limitations on the shadow generation method for a three-dimensional model above. Details are not described herein again.

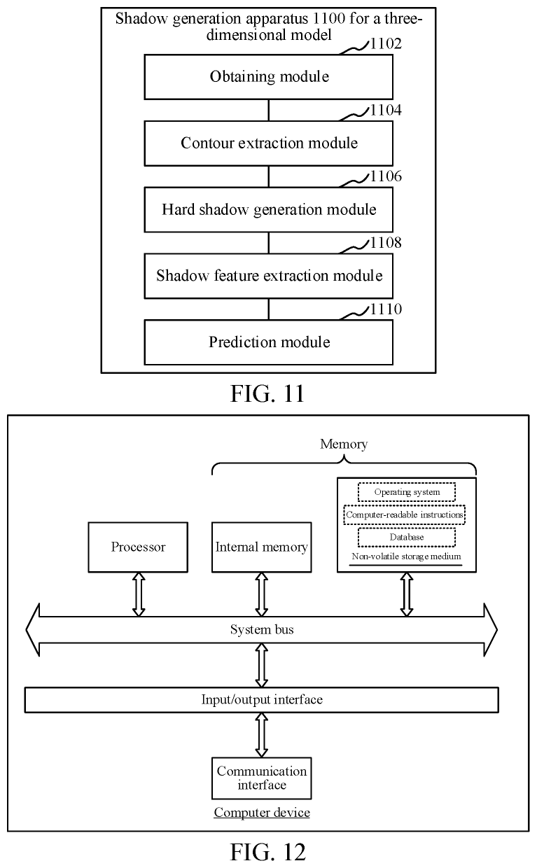

In an embodiment, as shown in FIG. 11, a shadow generation apparatus 1100 for a three-dimensional model is provided, including an obtaining module 1102, a contour extraction module 1104, a hard shadow generation module 1106, a shadow feature extraction module 1108 and a prediction module 1110, where the obtaining module 1102 is configured to obtain light source information of a virtual light source and an observation parameter of a virtual camera, the light source information being configured for forming an illumination effect of the virtual light source in a virtual scene, and the observation parameter being configured for forming a field-of-view range of the virtual camera in the virtual scene for a three-dimensional model;

The contour extraction module 1104 is configured to generate, based on the light source information and the observation parameter, a multi-angle contour map corresponding to the three-dimensional model, the multi-angle contour map being configured for representing an initial shadow;

The hard shadow generation module 1106 is configured to project, based on the light source information and the observation parameter, the multi-angle contour map onto a reference plane, to obtain a hard shadow image corresponding to the three-dimensional model;

The shadow feature extraction module 1108 is configured to obtain a shadow feature of the three-dimensional model based on the light source information and a material attribute of the three-dimensional model; and

The prediction module 1110 is configured to input the hard shadow image and the shadow feature into a convolutional neural network-based trained shadow prediction model, and output, based on the hard shadow image and the shadow feature through the shadow prediction model, a soft shadow image corresponding to the three-dimensional model.

In an embodiment, the contour extraction module 1104 is further configured to extract binary contour images of the three-dimensional model from a plurality of angles based on the light source information and the observation parameter, the binary contour images being images obtained by mapping the three-dimensional model onto a two-dimensional plane and performing binary distinction on an image foreground and an image background mapped onto the two-dimensional plane; and combine the binary contour images corresponding to all the angles, to obtain the multi-angle contour map corresponding to the three-dimensional model.

In an embodiment, the contour extraction module 1104 is further configured to convert the three-dimensional model into a triangular mesh including triangular patches; calculate, based on the light source information and the observation parameter, projection matrixes of the three-dimensional model from different angles, the different angles being different rotation angles when the three-dimensional model is rotated around a specified coordinate axis; project, for each angle, the triangular mesh onto the two-dimensional plane by using a corresponding projection matrix, to obtain a two-dimensional polygon from a corresponding angle; and extract, for each angle, an edge contour line of the two-dimensional polygon from the corresponding angle, to obtain the binary contour image of the three-dimensional model from the corresponding angle.

In an embodiment, the contour extraction module 1104 is further configured to perform a logical OR operation on the binary contour images corresponding to all the angles, to obtain the multi-angle contour map corresponding to the three-dimensional model.

In an embodiment, the contour extraction module 1104 is further configured to obtain a vertex set and a triangular patch set of the three-dimensional model, each triangular patch in the triangular patch set being represented by three vertex indexes, and all three vertexes identified by the three vertex indexes belonging to the vertex set; and generate the triangular mesh based on the vertex set and the triangular patch set.

In an embodiment, the contour extraction module 1104 is further configured to generate a corresponding normal vector for each triangular patch in the triangular patch set, the normal vector being a unit vector perpendicular to the triangular patch; determining, based on a direction vector of a light source and the normal vector, whether a patch direction of the triangular patch is an anticlockwise direction, the patch direction being determined by the three vertexes forming the triangular patch; exchange, when the patch direction of the triangular patch is not the anticlockwise direction, an order of latter two vertexes of the triangular patch, to obtain a triangular patch of which a patch direction is the anticlockwise direction; and store the vertex set and the triangular patch of the anticlockwise direction into a triangular mesh object, to obtain the triangular mesh corresponding to the three-dimensional model.

In an embodiment, the hard shadow generation module 1106 is further configured to calculate, based on the light source information and the observation parameter, a projection matrix corresponding to the multi-angle contour map on the reference plane; and project the multi-angle contour map onto the reference plane by using the projection matrix, to obtain the hard shadow image corresponding to the three-dimensional model.

In an embodiment, the hard shadow generation module 1106 is further configured to calculate, based on the observation parameter, a first transformation matrix configured for converting two-dimensional coordinates of a pixel in the multi-angle contour map into three-dimensional coordinates in a world coordinate system; calculate, based on the light source information, a second transformation matrix configured for converting the three-dimensional coordinates into projection coordinates on the reference plane; and calculate the projection matrix based on the first transformation matrix and the second transformation matrix.

In an embodiment, the hard shadow generation module 1106 is further configured to calculate a front orthogonal basis vector of the virtual camera based on a field-of-view direction vector of the virtual camera; calculate a right orthogonal basis vector of the virtual camera based on the front orthogonal basis vector and an up vector of the virtual camera; calculate an up orthogonal basis vector of the virtual camera based on the right orthogonal basis vector and the front orthogonal basis vector, the front orthogonal basis vector, the right orthogonal basis vector, and the up orthogonal basis vector of the virtual camera forming a camera coordinate system of the virtual camera; and calculate the first transformation matrix based on a position of the virtual camera and the front orthogonal basis vector, the right orthogonal basis vector, and the up orthogonal basis vector of the virtual camera, the first transformation matrix being configured for converting the camera coordinate system into the world coordinate system.

In an embodiment, the light source information includes a position of the virtual light source and a light source direction vector, and the hard shadow generation module 1106 is further configured to calculate a front orthogonal basis vector of the virtual light source based on a light source direction vector of the virtual light source; calculate a right orthogonal basis vector of the virtual light source based on the right orthogonal basis vector of the virtual camera; calculate an up orthogonal basis vector of the virtual light source based on the front orthogonal basis vector of the virtual light source and the right orthogonal basis vector of the virtual light source, the front orthogonal basis vector, the right orthogonal basis vector, and the up orthogonal basis vector of the virtual light source forming a light source coordinate system of the virtual light source; and calculate the second transformation matrix based on the position of the virtual light source and the front orthogonal basis vector, the right orthogonal basis vector, and the up orthogonal basis vector of the virtual light source, the second transformation matrix being configured for converting the world coordinate system into a projection coordinate system corresponding to the reference plane.

In an embodiment, the hard shadow generation module 1106 is further configured to multiply the second transformation matrix by the first transformation matrix, to obtain the projection matrix.

In an embodiment, the shadow feature extraction module 1108 is further configured to obtain coordinates of each vertex in the three-dimensional model, and calculate a normal vector corresponding to each vertex based on coordinates of adjacent vertexes; obtain a light source radius of the virtual light source and a light source distance between the virtual light source and the three-dimensional model, and calculate a light source size of the virtual light source based on the light source radius and the light source distance; obtain the material attribute of the three-dimensional model, the material attribute indicating diffuse reflectivity, specular reflectivity, roughness, and metallicity corresponding to each vertex in the three-dimensional model; and calculate comprehensive reflectivity corresponding to each vertex based on the diffuse reflectivity, specular reflectivity, roughness, and metallicity corresponding to each vertex; and obtain the shadow feature corresponding to the three-dimensional model based on the normal vector corresponding to each vertex, the light source size of the virtual light source, and the corresponding comprehensive reflectivity.

In an embodiment, the prediction module 1110 is further configured to map the shadow feature from vertex space to pixel space, to obtain a shadow feature map having a data size the same as that of the hard shadow image, concatenate the hard shadow image and the shadow feature map based on a channel by using an input layer of the shadow prediction model, to obtain an input tensor, and input the input tensor into the convolutional neural network-based trained shadow prediction model; successively perform feature encoding and feature downsampling on the input tensor through an encoder of the shadow prediction model, to obtain a high-resolution encoding feature, the encoder including a plurality of atrous convolutional layers and pooling layers that are alternately connected in sequence; successively perform feature decoding and feature upsampling on the high-resolution encoding feature through a decoder of the shadow prediction model, to obtain a low-resolution decoding feature, the decoder including a plurality of atrous convolutional layers and upsampling layers that are alternately connected in sequence; and convert the low-resolution decoding feature into an output tensor having a data size the same as that of the hard shadow image by using an output layer of the shadow prediction model, the output tensor being the soft shadow image corresponding to the three-dimensional model.

In an embodiment, the shadow generation apparatus 1100 further includes: a training module, configured to obtain a plurality of training samples, each of the training samples including the hard shadow image and the shadow feature corresponding to the three-dimensional model, and a sample soft shadow image corresponding to the hard shadow image; input, for each of the training samples, the corresponding hard shadow image and shadow feature map into an initial shadow prediction model, and output a corresponding predicted soft shadow image through the shadow prediction model; calculate, for each of the training samples, a difference between the corresponding predicted soft shadow image and the sample soft shadow image, and construct a loss function based on the differences corresponding to the plurality of samples; and update the shadow prediction model based on the loss function.

The foregoing shadow generation apparatus 1100 for a three-dimensional model obtains light source information of a virtual light source and an observation parameter of a virtual camera, the light source information being configured for representing an illumination effect of the virtual light source in a virtual scene, and the observation parameter being configured for representing a field-of-view range of the virtual camera in the virtual scene for a three-dimensional model; generates, based on the light source information and the observation parameter, a multi-angle contour map corresponding to the three-dimensional model, the multi-angle contour map being configured for representing an initial shadow; projects, based on the light source information and the observation parameter, the multi-angle contour map onto a reference plane, to obtain a hard shadow image corresponding to the three-dimensional model; obtains a shadow feature of the three-dimensional model based on the light source information and a material attribute of the three-dimensional model; and inputs the hard shadow image and the shadow feature into a convolutional neural network-based trained shadow prediction model, and outputs, based on the hard shadow image and the shadow feature through the shadow prediction model, a soft shadow image corresponding to the three-dimensional model. The soft shadow image may be configured for generating a more real and natural soft shadow effect. In other words, a single multi-angle contour map generation process with low consumption is required, and then the hard shadow image of the three-dimensional model is generated based on the multi-angle contour map. Therefore, a shadow effect of the three-dimensional model can be efficiently generated based on the hard shadow image and the shadow feature, so that a data processing volume during shadow generation is reduced, and shadow generation efficiency is improved.

All the modules in the shadow generation apparatus for a three-dimensional model may be implemented entirely or partially by using software, hardware, or a combination thereof. The foregoing modules may be built in or independent of a processor of a computer device in a form of hardware, or may be stored in a memory of the computer device in a form of software, for the processor to invoke to perform operations corresponding to the foregoing modules.

In an embodiment, a computer device is provided. The computer device may be a server, and a diagram of an internal structure thereof may be shown in FIG. 12. The computer device includes a processor, a memory, an input/output (referred to as I/O for short) interface, and a communication interface. The processor, the memory, and the input/output interface are connected via a system bus, and the communication interface is connected to the system bus via the input/output interface. The processor of the computer device is configured to provide computing and control capabilities. The memory of the computer device includes a non-volatile storage medium and an internal memory. The non-volatile storage medium has an operating system, computer-readable instructions, and a database stored therein. The internal memory provides a running environment for the operating system and the computer-readable instructions in the non-volatile storage medium. The input/output interface of the computer device is configured to exchange information between the processor and an external device. The communication interface of the computer device is configured to communicate with an external terminal through a network. The computer-readable instructions, when executed by the processor, implement a shadow generation method for a three-dimensional model.

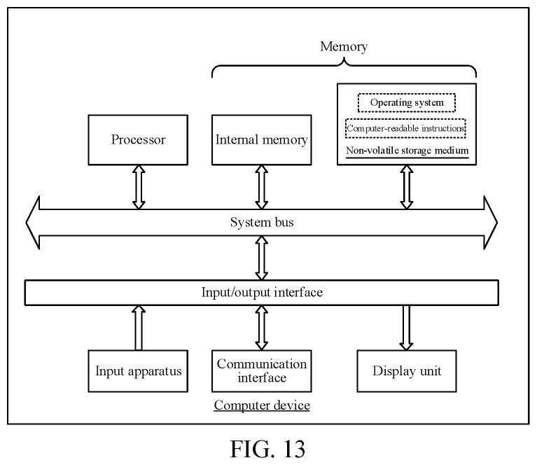

In an embodiment, a computer device is provided. The computer device may be a terminal, and a diagram of an internal structure thereof may be shown in FIG. 13. The computer device includes a processor, a memory, an input/output (I/O) interface, a communication interface, a display unit, and an input apparatus. The processor, the memory, and the input/output interface are connected via a system bus, and the communication interface, the display unit, and the input apparatus are connected to the system bus via the input/output interface. The processor of the computer device is configured to provide computing and control capabilities. The memory of the computer device includes a non-volatile storage medium and an internal memory. The non-volatile storage medium has an operating system and computer-readable instructions stored therein. The internal memory provides a running environment for the operating system and the computer-readable instructions in the non-volatile storage medium. The input/output interface of the computer device is configured to exchange information between the processor and an external device. The communication interface of the computer device is configured to communicate with an external terminal in a wired or wireless mode. The wireless mode may be implemented through Wi-Fi, a mobile cellular network, near field communication (NFC), or another technology. The computer-readable instructions, when executed by the processor, implement a shadow generation method for a three-dimensional model. The display unit of the computer device is configured to form a visual picture, and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, a touchpad, a mouse, or the like.

The structures shown in FIG. 12 and FIG. 13 are a block diagram of a part of a structure related to a solution of this disclosure and does not limit the computer device to which the solution of this disclosure is applied. The computer device may include more or fewer components than those in the drawings, or some components are combined, or a different component arrangement is used.

In an embodiment, a computer device is provided, including a memory and a processor. The memory has computer-readable instructions stored therein. The processor, when executing the computer-readable instructions, implements the operations of the shadow generation method for a three-dimensional model in the embodiments of this disclosure.

In an embodiment, a computer-readable storage medium is provided, having computer-readable instructions stored therein. The computer-readable instructions, when executed by a processor, implement the operations of the shadow generation method for a three-dimensional model in the embodiments of this disclosure.

In an embodiment, a computer program product is provided, including computer-readable instructions. The computer-readable instructions, when executed by a processor, implement the operations of the shadow generation method for a three-dimensional model in the embodiments of this disclosure.

It is noted that all or some of the processes of the methods in the foregoing embodiments may be implemented by computer-readable instructions instructing relevant hardware. The computer-readable instructions may be stored in a non-volatile computer-readable storage medium. When the computer-readable instructions are executed, the processes in the foregoing method embodiments may be implemented. Any reference to a memory, a database, or another medium used in the various embodiments provided herein may include at least one of a non-volatile and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric m random access memory (FRAM), a phase change memory (PCM), a graphene memory, and the like. The volatile memory may include a random access memory (RAM) or an external cache memory, and the like. For the purpose of description instead of limitation, the RAM is available in a plurality of forms, for example, a static RAM (SRAM) or a dynamic RAM (DRAM). The database in the embodiments provided in this application may include at least one of a relational database and a non-relational database. The non-relational database may include a blockchain-based distributed database and the like, but is not limited thereto. The processor involved in the embodiments provided in this application may be a general-purpose processor, a central processing unit, a graphics processing unit, a digital signal processor, a programmable logic device, a data processing logic device based on quantum computing, or the like, but is not limited thereto.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of shadow generation, the method comprising:
obtaining light source information of a virtual light source and one or more observation parameters of a virtual camera, the light source information indicating an illumination effect of the virtual light source in a virtual scene, and the one or more observation parameters defining a field-of-view range of the virtual camera in the virtual scene with a three-dimensional model;
generating, based on the light source information and the one or more observation parameters, a multi-angle contour map of the three-dimensional model, the multi-angle contour map being a combination of a plurality of binary contour images of the three-dimensional model from different angles;
projecting, based on the light source information and the one or more observation parameters, the multi-angle contour map onto a reference plane, to obtain a hard shadow image of the three-dimensional model;
obtaining a shadow feature of the three-dimensional model based on the light source information and a material attribute of the three-dimensional model; and
inputting the hard shadow image and the shadow feature into a convolutional neural network-based shadow prediction model that has been trained to cause the convolutional neural network-based shadow prediction model to output a soft shadow image of the three-dimensional model.

2. The method according to claim 1, wherein the generating the multi-angle contour map comprises:
extracting the plurality of binary contour images of the three-dimensional model from a plurality of angles based on the light source information and the one or more observation parameters, a binary contour image in the plurality of binary contour images being obtained by mapping the three-dimensional model onto a two-dimensional plane and performing binary distinction on an image that is mapped onto the two-dimensional plane according to foreground and background; and
combining the plurality of binary contour images to obtain the multi-angle contour map of the three-dimensional model.

3. The method according to claim 2, wherein the extracting comprises:
converting the three-dimensional model into a triangular mesh comprising triangular patches;
calculating, based on the light source information and the one or more observation parameters, a projection matrix of the three-dimensional model from an angle in the plurality of angles, the angle indicating a rotation angle of the three-dimensional model around a specified coordinate axis;
projecting the triangular mesh onto the two-dimensional plane by using the projection matrix, to obtain a two-dimensional polygon associated with the angle; and
extracting an edge contour line of the two-dimensional polygon associated with the angle, to obtain a binary contour image of the three-dimensional model from the angle.

4. The method according to claim 3, wherein the combining comprises:
performing a logical OR operation on the plurality of binary contour images from the plurality of angles, to obtain the multi-angle contour map of the three-dimensional model.

5. The method according to claim 3, wherein the converting comprises:
obtaining a vertex set and a triangular patch set of the three-dimensional model, the vertex set including a plurality of vertex indexes representing vertexes, each triangular patch in the triangular patch set including three vertexes that are represented respectively by three vertex indexes in the vertex set; and
generating the triangular mesh based on the vertex set and the triangular patch set.

6. The method according to claim 5, wherein the generating the triangular mesh based on the vertex set and the triangular patch set comprises:
generating a normal vector for a triangular patch in the triangular patch set, the normal vector being a unit vector perpendicular to the triangular patch;
determining, based on a direction vector of the virtual light source and the normal vector, whether the triangular patch has an anticlockwise direction in a patch direction according to an order of three vertexes in the triangular patch;
exchanging, when the patch direction of the triangular patch is not the anticlockwise direction, an order of last two vertexes of the triangular patch, to update the triangular patch to have the anticlockwise direction; and
storing the vertex set and at least the triangular patch that has been updated to have the anticlockwise direction into a triangular mesh object, to obtain the triangular mesh corresponding to the three-dimensional model.

7. The method according to claim 1, wherein the projecting comprises:
calculating, based on the light source information and the one or more observation parameters, a projection matrix for projecting the multi-angle contour map on the reference plane; and
projecting the multi-angle contour map onto the reference plane by using the projection matrix, to obtain the hard shadow image of the three-dimensional model.

8. The method according to claim 7, wherein the calculating the projection matrix comprises:
calculating, based on the one or more observation parameters, a first transformation matrix for converting two-dimensional coordinates of a pixel in the multi-angle contour map into three-dimensional coordinates in a world coordinate system;
calculating, based on the light source information, a second transformation matrix for converting the three-dimensional coordinates into projection coordinates on the reference plane; and
calculating the projection matrix based on the first transformation matrix and the second transformation matrix.

9. The method according to claim 8, wherein the calculating the first transformation matrix comprises:
calculating a front orthogonal basis vector of the virtual camera based on a field-of-view direction vector of the virtual camera;
calculating a right orthogonal basis vector of the virtual camera based on the front orthogonal basis vector and an up vector of the virtual camera;
calculating an up orthogonal basis vector of the virtual camera based on the right orthogonal basis vector and the front orthogonal basis vector, the front orthogonal basis vector, the right orthogonal basis vector, and the up orthogonal basis vector of the virtual camera forming a camera coordinate system of the virtual camera; and
calculating the first transformation matrix based on a position of the virtual camera, the front orthogonal basis vector, the right orthogonal basis vector, and the up orthogonal basis vector of the virtual camera, the first transformation matrix converting the camera coordinate system into the world coordinate system.

10. The method according to claim 8, wherein the light source information comprises a position of the virtual light source and a light source direction vector, and the calculating the second transformation matrix comprises:
calculating a front orthogonal basis vector of the virtual light source based on the light source direction vector of the virtual light source;
calculating a right orthogonal basis vector of the virtual light source based on a right orthogonal basis vector of the virtual camera;
calculating an up orthogonal basis vector of the virtual light source based on the front orthogonal basis vector of the virtual light source and the right orthogonal basis vector of the virtual light source, the front orthogonal basis vector, the right orthogonal basis vector, and the up orthogonal basis vector of the virtual light source forming a light source coordinate system of the virtual light source; and
calculating the second transformation matrix based on the position of the virtual light source, the front orthogonal basis vector, the right orthogonal basis vector, and the up orthogonal basis vector of the virtual light source, the second transformation matrix converting the world coordinate system into a projection coordinate system of the reference plane.

11. The method according to claim 8, wherein the calculating the projection matrix comprises:
multiplying the second transformation matrix by the first transformation matrix, to obtain the projection matrix.

12. The method according to claim 1, wherein the obtaining the shadow feature of the three-dimensional model comprises:
obtaining coordinates of each vertex in the three-dimensional model;
calculating a respective normal vector of each vertex based on coordinates of adjacent vertexes;
obtaining a light source radius of the virtual light source and a light source distance between the virtual light source and the three-dimensional model;
calculating a light source size of the virtual light source based on the light source radius and the light source distance;
obtaining the material attribute of the three-dimensional model, the material attribute indicating diffuse reflectivity, specular reflectivity, roughness, and metallicity of each vertex in the three-dimensional model;
calculating a respective comprehensive reflectivity of each vertex based on the diffuse reflectivity, specular reflectivity, roughness, and metallicity of each vertex; and
obtaining the shadow feature of the three-dimensional model based on the respective normal vector and the respective comprehensive reflectivity of each vertex, and the light source size of the virtual light source.

13. The method according to claim 1, wherein the inputting the hard shadow image and the shadow feature comprises:
mapping the shadow feature from a vertex space to a pixel space, to obtain a shadow feature map having a same data size as the hard shadow image, concatenating the hard shadow image and the shadow feature map based on an input layer of the convolutional neural network-based shadow prediction model, to obtain an input tensor;
inputting the input tensor into the convolutional neural network-based shadow prediction model;
performing feature encoding and feature downsampling on the input tensor by using an encoder of the convolutional neural network-based shadow prediction model, to obtain a high-resolution encoding feature, the encoder comprising a plurality of atrous convolutional layers and pooling layers that are alternately connected in sequence;
performing feature decoding and feature upsampling on the high-resolution encoding feature by using a decoder of the convolutional neural network-based shadow prediction model, to obtain a low-resolution decoding feature, the decoder comprising a plurality of atrous convolutional layers and upsampling layers that are alternately connected in sequence; and
converting the low-resolution decoding feature into an output tensor having the same data size as the hard shadow image by using an output layer of the convolutional neural network-based shadow prediction model, the output tensor being the soft shadow image of the three-dimensional model.

14. The method according to claim 1, wherein the convolutional neural network-based shadow prediction model is trained by training operations, the training operations comprise:
obtaining a plurality of training samples, each of the plurality of training samples comprising a sample hard shadow image and a sample shadow feature of a sample three-dimensional model, and a sample soft shadow image of the sample hard shadow image;
inputting, for each of the plurality of training samples, the sample hard shadow image and the sample shadow feature into an initial shadow prediction model to generate a predicted soft shadow image by the initial shadow prediction model;
calculating, for each of the plurality of training samples, a difference between the predicted soft shadow image and the sample soft shadow image;
constructing a loss function based on the differences of the plurality of training samples; and
updating the initial shadow prediction model based on the loss function.

15. An apparatus of shadow generation, comprising processing circuitry configured to:
obtain light source information of a virtual light source and one or more observation parameters of a virtual camera, the light source information indicating an illumination effect of the virtual light source in a virtual scene, and the one or more observation parameters defining a field-of-view range of the virtual camera in the virtual scene with a three-dimensional model;
generate, based on the light source information and the one or more observation parameters, a multi-angle contour map of the three-dimensional model, the multi-angle contour map being a combination of a plurality of binary contour images of the three-dimensional model from different angles;
project, based on the light source information and the one or more observation parameters, the multi-angle contour map onto a reference plane, to obtain a hard shadow image of the three-dimensional model;
obtain a shadow feature of the three-dimensional model based on the light source information and a material attribute of the three-dimensional model; and
input the hard shadow image and the shadow feature into a convolutional neural network-based shadow prediction model that has been trained to cause the convolutional neural network-based shadow prediction model to output a soft shadow image of the three-dimensional model.

16. The apparatus according to claim 15, wherein the processing circuitry is configured to:
extract the plurality of binary contour images of the three-dimensional model from a plurality of angles based on the light source information and the one or more observation parameters, a binary contour image in the plurality of binary contour images being obtained by mapping the three-dimensional model onto a two-dimensional plane and performing binary distinction on an image that is mapped onto the two-dimensional plane according to foreground and background; and
combine the plurality of binary contour images to obtain the multi-angle contour map of the three-dimensional model.

17. The apparatus according to claim 16, wherein the processing circuitry is configured to:
convert the three-dimensional model into a triangular mesh comprising triangular patches;
calculate, based on the light source information and the one or more observation parameters, a projection matrix of the three-dimensional model from an angle in the plurality of angles, the angle indicating a rotation angle of the three-dimensional model around a specified coordinate axis;
project the triangular mesh onto the two-dimensional plane by using the projection matrix, to obtain a two-dimensional polygon associated with the angle; and
extract an edge contour line of the two-dimensional polygon associated with the angle, to obtain a binary contour image of the three-dimensional model from the angle.

18. The apparatus according to claim 17, wherein the processing circuitry is configured to:
perform a logical OR operation on the plurality of binary contour images from the plurality of angles, to obtain the multi-angle contour map of the three-dimensional model.

19. The apparatus according to claim 17, wherein the processing circuitry is configured to:
obtain a vertex set and a triangular patch set of the three-dimensional model, the vertex set including a plurality of vertex indexes representing vertexes, each triangular patch in the triangular patch set including three vertexes that are represented respectively by three vertex indexes in the vertex set; and
generate the triangular mesh based on the vertex set and the triangular patch set.

20. A non-transitory computer-readable storage medium storing instructions which when executed by a processor cause the processor to perform:
obtaining light source information of a virtual light source and one or more observation parameters of a virtual camera, the light source information indicating an illumination effect of the virtual light source in a virtual scene, and the one or more observation parameters defining a field-of-view range of the virtual camera in the virtual scene with a three-dimensional model;
generating, based on the light source information and the one or more observation parameters, a multi-angle contour map of the three-dimensional model, the multi-angle contour map being a combination of a plurality of binary contour images of the three-dimensional model from different angles;
projecting, based on the light source information and the one or more observation parameters, the multi-angle contour map onto a reference plane, to obtain a hard shadow image of the three-dimensional model;
obtaining a shadow feature of the three-dimensional model based on the light source information and a material attribute of the three-dimensional model; and
inputting the hard shadow image and the shadow feature into a convolutional neural network-based shadow prediction model that has been trained to cause the convolutional neural network-based shadow prediction model to output a soft shadow image of the three-dimensional model.
